(19) United States
(12) Patent Application Publication
(10) Pub. No.: US 2002/0069351 A1
(43) Pub. Date: Jun. 6, 2002

(54) Memory data access structure and method suitable for use in a processor

(76) Inventors: Shyh-An Chi, Hsinchu (TW); Calvin Guey, Taipei Hsien (TW); Yu-Min Wang, Taichung (TW)

Correspondence Address: J.C. PATENTS INC., 4 VENTURE, SUITE 250, IRVINE, CA, 92618, US

(21) Appl. No.: 09/752,122

(22) Filed: Dec. 29, 2000

(30) Foreign Application Priority Data
Dec. 5, 2000 (TW) 89125861

(51) Int. Cl. G06F 9/32

(52) U.S. Cl. 712/239

(57) ABSTRACT

A memory data access structure and an access method suitable for use in a processor. For each instruction executed by the processor, the execution results are recognized by the processor and transferred to a cache memory via control signals. When the instruction to be fetched is not stored in the cache memory, according to the control signals, the cache memory can determine whether the instruction is to be fetched from an external memory. With such structure, no matter whether the processor comprises a branch prediction mechanism or not, many operation clock cycles consumed in the processor of the prior art are saved by compensating for the situation that the cache memory fails to fetch, that is, a Miss of the cache memory. The efficiency and performance of the processor can be effectively enhanced.

### CROSS-REFERENCE TO RELATED APPLICATION

This application claims the priority benefit of Taiwan application serial no. 89125861, filed Dec. 5, 2000.

### BACKGROUND OF THE INVENTION

1. Field of the Invention

The invention relates in general to a memory data access structure and an access method. More particularly, the invention relates to a memory data access structure and an access method suitable for use in a processor.

2. Description of the Related Art

A processor is an indispensable device widely applied in current electronic equipment. For example, a central processing unit in a personal computer provides various functions according to specific requirements. As the function of the electronic equipment becomes more and more versatile, the processor has to be smarter and smarter.

In the conventional processor, the process of instruction can be referred to using a block diagram of memory data access as shown in FIG. 1. The flow chart between the memory data access control and the processor is illustrated. A central processing unit (CPU) is used as an example here. The memory data access structure comprises a central processing unit 100, a cache memory 120 and a memory 130. The central processing unit 100 is connected to the cache memory 120 and the memory 130 via a data bus (DS) 102 for data transfer. In addition, via an address bus (AB) 104, the central processing unit 100 transfers address data to the cache memory 120 and the memory 130. The cache memory 120 is controlled by the central processing unit 100 via a control signal (CS) 106.

Assume that the interior of the central processing unit 100 is divided into three pipeline stages. That is, while executing an instruction, a fetch instruction stage, a decode instruction stage and an execution instruction stage are performed. The central processing unit 100 first fetches an instruction from the cache memory 120. The fetched instruction is then decoded, followed by an execution operation on the decoded instruction. If the required instruction is not stored in the cache memory 120, the central processing unit 100 fetches the instruction from the memory 130. Due to the speed limitations of the hardware, many operation clock cycles of the central processing unit 100 are wasted.

Among the execution instructions of the central processing unit 100, a branch instruction is included. This branch instruction belongs to a control transfer instruction that requires the next instruction to be executed by the central processing unit 100 located at a certain address. That is, the central processing unit 100 has to jump from the current processing address to a desired address. This kind of instruction includes jump instructions, subroutine call instructions or return instructions.

In FIG. 2A, program segments are illustrated as an example for description. I is the instruction that the central processing unit 100 is to execute. I₁, I₂, . . . I₁₀, I₁₁, . . . represent the first, second, . . . , tenth, eleventh, . . . instructions. The instruction I₁ is a branch instruction. After executing the instruction I₁, it jumps to the instruction I₁₀.

In FIG. 2B, the relationship is shown between the clock signals and the fetch, decode and execution stages for the program segments as shown in FIG. 2A. The operation clock C comprises C₁, C₂, C₃, . . . , C₈ to represent the first, second, third, . . . , eighth clock. When the instruction I₁ is in the execution stage, that is, at the third clock C₃, the fetch unit of the central processing unit 100 starts fetching the instruction I₃. Meanwhile, if the instruction I₃ is not in the cache memory 120, the central processing unit 100 fetches the instruction I₃ from the memory 130.

However, the instruction I₁ belongs to a branch instruction, so that the execution direction of the program will be redirected. For example, the instruction I₁₀ is fetched instead of the instruction I₃ while the request to fetch instruction I₃ has been sent to the memory 130. Thus, the central processing unit 100 has to wait until the completion of the request to fetch instruction I₃ in the cache memory 120. As shown in FIG. 2B, assuming that the fetch instruction of the memory 130 consumes 3 operation clock cycles to complete, the clock numbers for fetching instructions from the memory 130 becomes larger and larger as the speed gap between the central processing unit 100 and the memory 130 increases. The whole operation of the central processing unit 100 is clearly depicted from FIG. 2B. After execution of the branch instruction (after the clock C₃), the instruction I₁₀ is fetched at clock C₆. Many clocks are wasted. For a high efficiency and high processing speed processor, the delay is fatal.

The prior art further provides a branch prediction mechanism to predict whether the instruction is a branch instruction in the fetch stage and further predict whether the execution direction is changed. However, the above problems will still occur in such a processor with the branch prediction mechanism. I₁ is assumed as a taken branch that may change the execution direction to I₁₀. While fetching I₁ at clock C₁, if the branch prediction mechanism made a wrong prediction, such as I₁, is not a branch instruction or I₁will not change the execution direction, the central processing unit 100 still starts fetching I₃ during the execution of the instruction I₁ at C₃. If I₃ is not stored in the cache memory 120 in the above example, the above drawbacks occur. If I₁ is predicted as a branch instruction but may not change the program execution direction, when the branch instruction makes a wrong prediction, the same problems may occur.

### SUMMARY OF THE INVENTION

The invention provides a memory data access structure and an access method suitable for use in a processor. While executing a branch instruction, the situation of fetching an instruction that is not used currently, which wastes processing time, is avoided. Therefore, the operation clock delay is avoided.

The memory data access structure and method further avoids the waste of operation clock cycles while executing the branch instruction no matter whether the processor comprises a branch prediction mechanism or not.

To achieve these and other advantages and in accordance with the purpose of the invention, as embodied and broadly described herein, the invention provides a memory data access structure suitable for use in a processor. The structure comprises a cache memory and a pipeline processor. The cache memory is used to store and output an instruction according to an address signal. The pipeline processor is used for executing a plurality of processor instructions, the pipeline processor including an execution unit to perform an execution operation on the instruction input from a previous stage, and to output a result signal and a control signal, wherein the control signal is output to the cache memory. When the instruction executed by the execution unit is a branch instruction, the result signal is a target address. The target address is selected to be an address signal output to the cache memory. The cache memory fetches an next instruction to be executed according to the address signal. When the execution unit is executing the branch instruction, the processor is fetching a fetch instruction from the cache memory, and when the control signal obtained after executing the branch instruction is output to the cache memory, if the fetch instruction is not stored in the cache memory, the cache memory determines whether to fetch the fetch instruction from an external memory according to the control signal.

In the above-mentioned memory data access structure, the control signal indicates whether the instruction executed in the current stage is a taken branch instruction.

In the above-mentioned memory data access structure further comprises a program counter to store an address of the instruction currently executed among all the instructions to be executed.

In the above-mentioned memory data access structure, further comprises a multiplexer to receive the result signal output by the execution unit and the executed address stored in the program counter plus a set value, and to select one of the signals as the address signal.

To achieve these and other advantages and in accordance with the purpose of the invention, as embodied and broadly described herein, the invention provides a memory data access structure suitable for use in a processor. The memory data access structure comprises a cache memory, a pipeline processor, a branch instruction prediction mechanism and a comparator. The cache memory is used to store and output an instruction according to an address signal. The pipeline processor is used for executing a plurality of processor instructions, including an execution unit to perform an execution operation on an instruction transferred from a previous stage, and to output a result signal. The branch instruction prediction mechanism is used to output a predicted address according to a fetch instruction. The comparator is used to receive the result signal and the predicted address and to output a comparison signal. When the execution unit is executing a branch instruction, the result signal is a target address. The target address is selected to be an address signal output to the cache memory. An next instruction to be executed is fetched according to the address signal. When the execution unit is executing the branch instruction, the processor fetches the fetch instruction, and the result signal obtained after executing the branch instruction is transferred to the comparator, the comparator then outputs the comparison signal to the cache memory according to the result signal and the predicted address, if the fetch instruction is not stored in the cache memory, the cache memory determines whether to fetch the fetch instruction from an external memory according to the comparison signal.

In the above-mentioned memory data access structure, the comparison signal is generated after performing comparison operation upon the result signal and the predicted address.

In the above-mentioned memory data access structure, further comprises a program counter to store an address of an instruction which is executed currently among all the instructions to be executed.

In the above-mentioned memory data access structure, further comprises a multiplexer to receive the result signal output from the execution unit, an execution address stored in the program counter plus a signal with a determined value, and the predicted address, and to select one of these signals as an address signal.

To achieve these and other advantages and in accordance with the purpose of the invention, as embodied and broadly described herein, the invention provides a method of memory data access suitable for use in a processor, comprising: providing an instruction according to an address signal; executing the instruction to output a result signal and a control signal; fetching a next instruction to be executed according to an address signal, wherein when the instruction is a branch instruction, the result signal is a target address, wherein the target address is selected to be the address signal output to the cache memory; and determining whether a fetch instruction is fetched from an external memory according to the control signal when the processor is fetching the fetch instruction and the fetch instruction is not stored in the cache memory.

In the above-mentioned method of memory data access suitable for use in a processor, the control signal indicates whether the instruction currently executed is a taken branch instruction.

In the above-mentioned method of memory data access suitable for use in a processor, further comprises the step of selectively outputting the result signal and an address of the instruction executed currently plus a signal with a certain value.

To achieve these and other advantages and in accordance with the purpose of the invention, as embodied and broadly described herein, the invention provides a method for memory data access suitable for use in a processor, comprising: providing an instruction; executing the instruction to output a result signal; using a branch prediction mechanism to receive a fetch instruction and to output a predicted address; comparing the result signal with the predicted address, and outputting a comparison signal. When the instruction being executed is a branch instruction, the result signal is a target address and is selected to be an address signal, the processor fetches an instruction to be executed next according to the address signal. While executing the branch instruction, the processor fetches the fetch instruction, if the fetch instruction is not in a cache memory, according to the comparison signal, the cache memory determines whether to fetch the fetch instruction from an external memory.

In the above-mentioned method of memory data access suitable for use in a processor, further comprises a step of selectively outputting one of the result signals, an address that the processor is currently processing plus a certain value, and the predicted address.

In the above-mentioned method of memory data access suitable for use in a processor, the comparison signal indicates whether the branch instruction predicted by the branch prediction mechanism is correct.

Both the foregoing general description and the following detailed description are exemplary and explanatory only and are not restrictive of the invention, as claimed.

### BRIEF DESCRIPTION OF THE DRAWINGS

FIG. 1 shows a block diagram of a conventional memory data access structure;

FIG. 2A shows examples of program segments;

FIG. 2B shows the relationship between the clock signal and the program segment executed in the fetch stage, the decode stage and the execution stage;

FIG. 3 shows the memory data access structure and method for a processor (without branch prediction mechanism) according to a preferred embodiment of the invention;

FIG. 4 shows another embodiment of a memory data access structure and method for a processor with branch prediction mechanism according to a preferred embodiment of the invention; and

FIG. 5 shows the relationships between the clock signal and the program segment executed in the fetch stage, the decode stage and the execution stage according to a preferred embodiment of the invention.

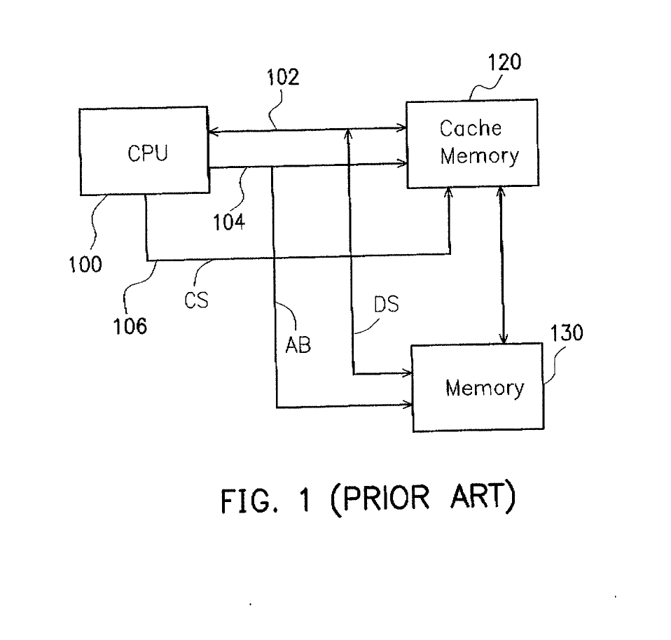

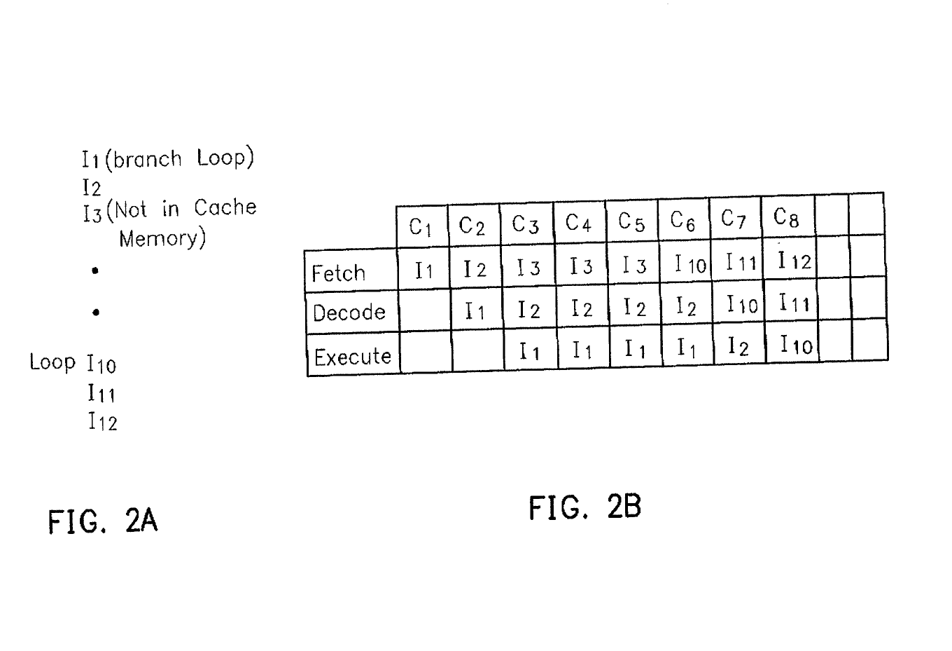

### DESCRIPTION OF THE PREFERRED EMBODIMENTS

The invention provides a memory data access structure and method suitable for use in a processor. In the memory data access structure, for each instruction that enters an execution stage executed by the processor, the execution result is recognised by the processor and sent to a cache memory via a control signal. According to the control signal, the cache memory determines whether to fetch an instruction from an external memory. Such structure, with or without a branch prediction mechanism, will not waste too many operation clocks generated as in the prior art. The “miss” that happened to the cache memory can thus be compensated, and the performance of the processor can be effectively enhanced.

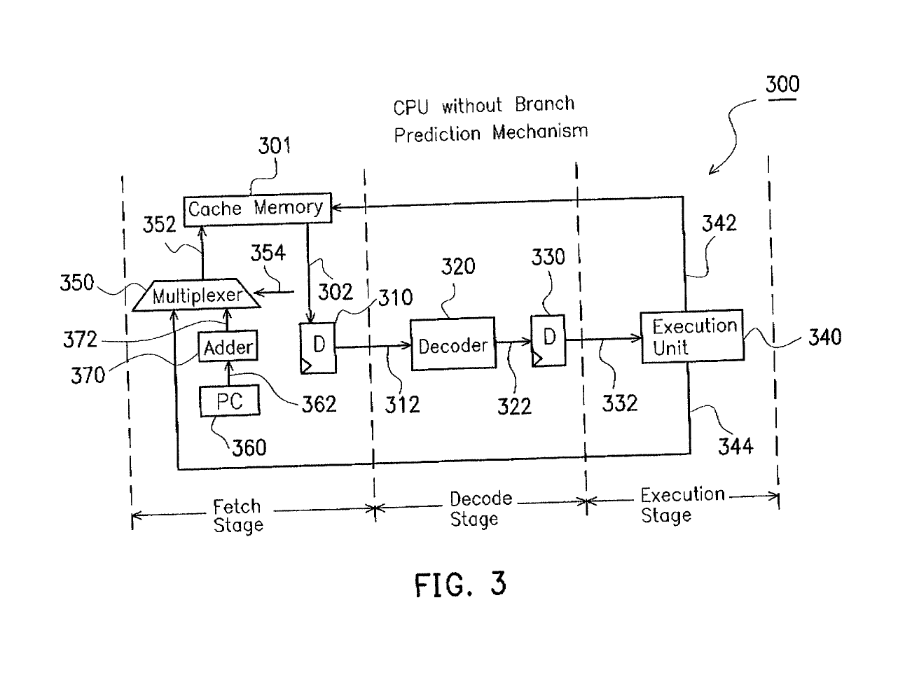

FIG. 3 shows the memory access structure and method of a processor of a preferred embodiment of the invention. In this structure, a central processing unit (CPU) 300 without a branch prediction mechanism is used. It is appreciated that the invention is not restricted to the application of a central processing unit. Those pipeline processors with functions of instruction fetching, decoding and executing are all within the scope of the invention. In this embodiment, the central processing unit 300 is a pipeline processor including at least three pipeline stages. That is, while executing an instruction, a fetch stage, a decode stage and an execution stage have to be performed.

As shown in FIG. 3, the central processing unit 300 comprises a D-type flip flop 310, a decoder 320, a D-type flip flop 330 and an execution unit 340. The D-type flip flop 310 receives an instruction input by a cache memory 301 via the line 302. A clock delay of the instruction is generated by the D-type flip flop 310 and sent to the decoder 320. Being decoded by the decoder 320, the instruction is transferred to the other D-type flip flop 330 via the line 322 to have another clock delay. The instruction is further sent to the execution unit 340 for execution via the line 332.

After execution, the execution unit 340 transfers a control signal, for example, an execution result, to the cache memory 301. The execution result must reflect whether the instruction executed currently is a branch instruction and whether it is taken or not. According to the control signal, the cache memory 301 determines whether the missed instruction, that is, the instruction not stored in the cache memory 301 such as I₃ introduced in prior art, should be fetched from an external memory. If not, the instruction will not be fetched from the external memory. That is, no request to fetch such instruction is generated. Therefore, the clock delay that occurs in the prior art is avoided.

In addition, the execution result is sent to a multiplexer 350. If the executed instruction is a branch instruction, the result is a target address. The multiplexer 350 is also connected to a program counter (PC) 360 of the central processing unit 300. The program counter 360 stores the address of the currently executed instruction among the instructions to be executed. An adder 370 is included between the multiplexer 350 and the program counter 360. The program counter 360 outputs the address of the current executed instruction to the adder 370. After an addition operation, the instruction is sent to the multiplexer 350. If a branch instruction is executed, the execution result of the branch instruction and the data output by the adder 370 are output as an address signal or a target address from the multiplexer 350 to the cache memory 301. The address of the next instruction to be executed is thus announced.

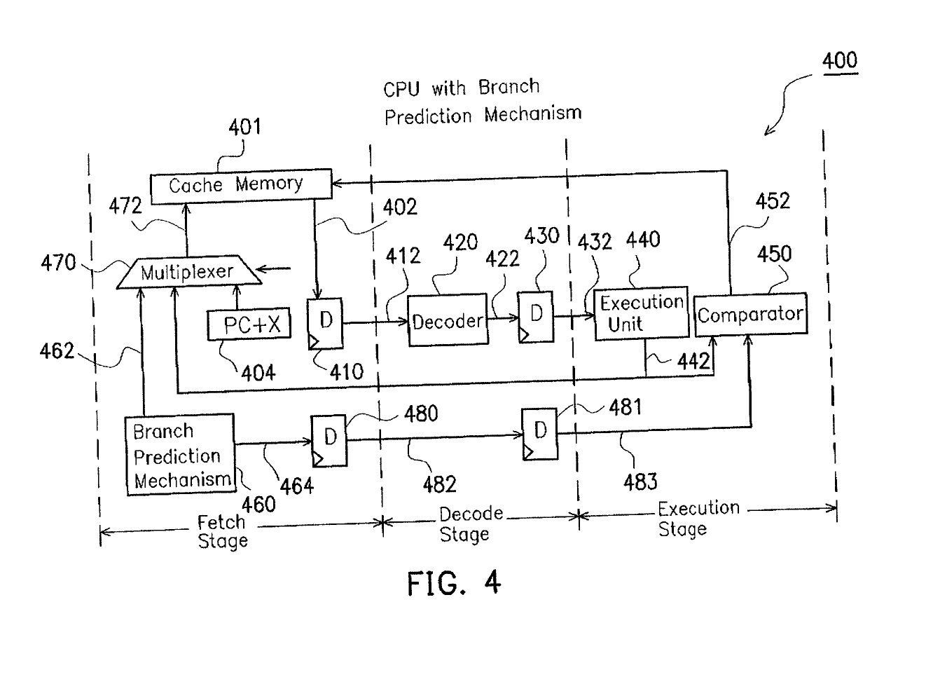

FIG. 4 shows another embodiment of memory data access structure and method of a processor. In this structures, a branch prediction mechanism is included in a central processing unit 400. Again, the invention is not restricted to the application of a central processing unit. All pipeline processors with the instruction fetch, decode and execution function are within the scope of the invention.

As shown in FIG. 4, the central processing unit 400 comprises a D-type flip flop 410, a decoder 420, a D-type flip flop 430, an execution unit 440, a comparator 450 and a branch prediction mechanism 460.

The D-type flip flop 410 receives an instruction from the cache memory 401 via the line 402 and this generates a clock delay on the instruction. The instruction is then sent to the decoder 420. Being decoded by the decoder 420, the instruction is sent to the D-type flip flop 430 via the line 422. Another clock delay is generated on the instruction which is then sent to the execution unit 440 for execution via line 432.

After execution, the execution unit 440 outputs an execution result. The branch prediction mechanism 460 receives an instruction or an instruction address respectively via the line 402 or line 472. The branch prediction mechanism 460 then outputs a predicted address to the comparator 450 (via the line 464, the D-type flip flop 480, the line 482, the D-type flip flop 481 and line 483) according to the received instruction or the instruction address. The comparator 450 then outputs a comparison signal to the cache memory 401 via the line 452. The comparison signal transferred to the cache memory 401 is generated after performing comparison operation upon the result signal from the execution unit 440 and the predicted address from the branch prediction mechanism 460. The cache memory 401 then determines whether it is necessary to fetch the missed instruction according to the comparison signal. The missed instruction means that the instruction not stored in the cache memory 401. If it is not necessary, the instruction is not to fetch from the external memory. That is, no request of fetch instruction is generated. Therefore, the clock delay is avoided.

In addition, the execution result is sent to a multiplexer 470. The multiplexer 470 also receives a signal 404 being processed (PC+X) by the adder 404. The “X” means an instruction size of the currently executed instruction. The predicted address output by the branch prediction mechanism 460 is also sent to the multiplexer 470 via the line 462. If the instruction executed by the execution unit 440 is a branch instruction, the execution result is a target address. According to these signals, the multiplexer 470 outputs an address signal to the cache memory 401 for instruction fetching.

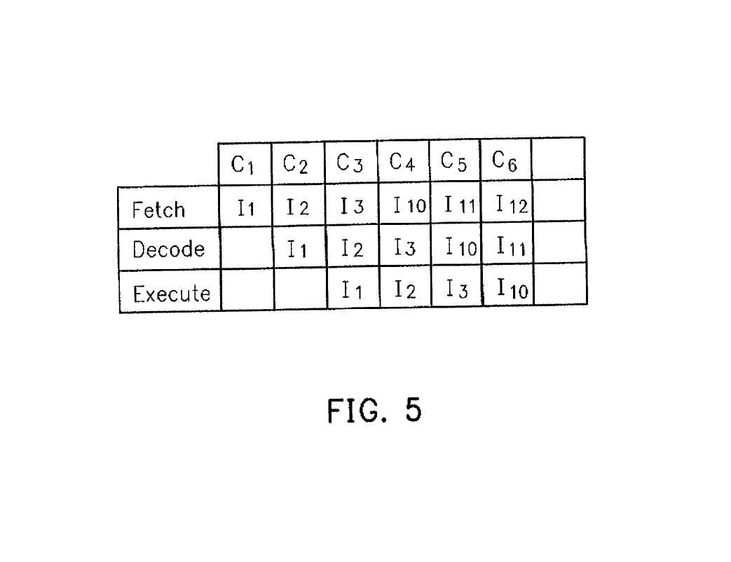

FIG. 5 shows the relationship between the clock signal and the program segments executed in the fetch stage, the decode stage and the execution stage. In FIG. 5, the clock C₁, C₂, C₃, . . . , C₈ are the first, second, third, . . . , eighth clock. When the instruction I₁ is in the execution stage, that is, at the third clock C₃, the central processing unit fetches the instruction I₃ from the cache memory. Meanwhile, if the instruction I₃ is not stored in the cache memory 120, according to the control signal or compression signal, as described in the above-mentioned preferred embodiments referring to FIG. 4 and FIG. 5, the cache memory determines whether to fetch the instruction from an external memory.

If I₁ is a branch instruction, the instruction I₁ will change the execution direction. In this example, the instruction I₁ is to change the execution direction to start fetching the instruction I₁₀. Meanwhile, the cache memory determines that the request for fetching the instruction I₃ is not output to the external memory. Thus, the central processing unit starts fetching instruction I₁₀ at the target address to be executed by the branch instruction in the next clock. Thus designed, without waiting for the cache memory to fetch the instruction I₃, the instruction at the target address can be fetched.

According to the memory data access structure and method, the operation clocks wasted in the prior art can be effectively saved. For the high efficiency and high processing speed processor, the performance can be greatly enhanced.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A memory data access structure suitable for use in a processor, comprising:
a cache memory, to store and output an instruction according to an address signal; and
a pipeline processor, for executing a plurality of processor instructions, the pipeline processor including an execution unit to perform an execution operation on the instruction input from a previous stage, and to output a result signal and a control signal, wherein the control signal is output to the cache memory, wherein
when the instruction executed by the execution unit is a branch instruction, the result signal is a target address, wherein the target address is selected to be an address signal output to the cache memory, wherein the cache memory fetches an next instruction to be executed according to the address signal;
when the execution unit is executing the branch instruction, the processor is fetching a fetch instruction from the cache memory, and when the control signal obtained after executing the branch instruction is output to the cache memory, if the fetch instruction is not stored in the cache memory, the cache memory determines whether to fetch the fetch instruction from an external memory according to the control signal.

2. The memory data access structure according to claim 1, wherein the control signal indicates whether the instruction executed in the current stage is a taken branch instruction.

3. The memory data access structure according to claim 1, further comprising a program counter to store an address of the instruction currently executed among all the instructions to be executed.

4. The memory data access structure according to claim 3, further comprising a multiplexer to receive the result signal output by the execution unit and the executed address stored in the program counter plus a set value, and to select one of the signals as the address signal.

5. A memory data access structure suitable for use in a processor, comprising
a cache memory, to store and output an instruction according to an address signal;
a pipeline processor, for executing a plurality of processor instructions, including an execution unit to perform an execution operation on an instruction transferred from a previous stage, and to output a result signal;
a branch instruction prediction mechanism, to output a predicted address according to a fetch instruction; and
a comparator, to receive the result signal and the predicted address and to output a comparison signal, wherein
when the execution unit is executing a branch instruction, the result signal is a target address, wherein the target address is selected to be an address signal output to the cache memory, wherein an next instruction to be executed is fetched according to the address signal,
when the execution unit is executing the branch instruction, the processor fetches the fetch instruction, and the result signal obtained after executing the branch instruction is transferred to the comparator, the comparator then outputs the comparison signal to the cache memory according to the result signal and the predicted address, if the fetch instruction is not stored in the cache memory, the cache memory determines whether to fetch the fetch instruction from an external memory according to the comparison signal.

6. The memory data access structure according to claim 5, wherein the comparison signal is generated after performing comparison operation upon the result signal and the predicted address.

7. The memory data access structure according to claim 5, further comprising a program counter to store an address of an instruction which is executed currently among all the instructions to be executed

8. The memory data access structure according to claim 7, comprising further a multiplexer to receive the result signal output from the execution unit, an execution address stored in the program counter plus a signal with a determined value, and the predicted address, and to select one of these signals as an address signal

9. A method of memory data access suitable for use in a processor, comprising:
providing an instruction according to an address signal;
executing the instruction to output a result signal and a control signal;
fetching a next instruction to be executed according to an address signal, wherein when the instruction is a branch instruction, the result signal is a target address, wherein the target address is selected to be the address signal output to the cache memory; and
determining whether a fetch instruction is fetched from an external memory according to the control signal when the processor is fetching the fetch instruction and the fetch instruction is not stored in the cache memory.

10. The method according to claim 9, wherein the control indicates whether the instruction currently executed is a taken branch instruction.

11. The method according to claim 9, comprising further the step of selectively outputting the result signal and an address of the instruction executed currently plus a signal with a certain value.

12. A method for memory data access suitable for use in a processor, comprising:
providing an instruction;
executing the instruction to output a result signal;
using a branch prediction mechanism to receive a fetch instruction and to output a predicted address;
comparing the result signal with the predicted address, and outputting a comparison signal, wherein
when the instruction being executed is a branch instruction, the result signal is a target address and is selected to be an address signal, the processor fetches an instruction to be executed next according to the address signal;
while executing the branch instruction, the processor fetches the fetch instruction, if the fetch instruction is not in a cache memory, according to the comparison signal, the cache memory determines whether to fetch the fetch instruction from an external memory.

13. The method according to claim 12, comprising further a step of selectively outputting one of the result signals, an address that the processor is currently processing plus a certain value, and the predicted address.

14. The method according to claim 12, wherein the comparison signal indicates whether the branch instruction predicted by the branch prediction mechanism is correct.
